(19) United States
(12) Patent Application Publication
(10) Pub. No.: US 2026/0046679 A1
(43) Pub. Date: Feb. 12, 2026

(54) METHOD AND APPARATUS FOR QUALITY OF SERVICE HANDLING

(71) Applicant: Telefonaktiebolaget LM Ericsson (publ), Stockholm (SE)

(72) Inventors: Chunmiao Liu, Shanghai (CN); Yixin Chen, Shanghai (CN); Yingjiao He, Shanghai (CN); Jinyin Zhu, Shanghai (CN); Yang Li, Shanghai (CN)

(21) Appl. No.: 19/101,389

(22) PCT Filed: Jul. 19, 2023
(86) PCT No.: PCT/EP2023/069991

§ 371 Date: Feb. 5, 2025

(30) Foreign Application Priority Data
Aug. 12, 2022 (WO) PCT/CN2022/112104

(51) Int. Cl. H04W 28/02; H04L 47/2491

(52) U.S. Cl. CPC H04W 28/0268; H04L 47/2491

(57) ABSTRACT

Various embodiments of the present disclosure provide a method for quality of service (QoS) handling. The method which may be performed by a first network node serving a first network comprises: receiving a first message transmitted by a second network node serving a second network. The first message indicates a list of candidate values provided for a QoS attribute of a session by the second network according to an agreement between the first network and the second network. In accordance with an exemplary embodiment, the method further comprises: obtaining a value for the QoS attribute of the session selected from the list of the candidate values.

### FIELD OF THE INVENTION

The present disclosure generally relates to communication networks, and more specifically, to a method and apparatus for quality of service (QoS) handling.

### BACKGROUND

This section introduces aspects that may facilitate a better understanding of the disclosure. Accordingly, the statements of this section are to be read in this light and are not to be understood as admissions about what is in the prior art or what is not in the prior art.

Communication service providers and network operators have been continually facing challenges to deliver value and convenience to consumers by, for example, providing compelling network services and performance. With the rapid development of networking and communication technologies, wireless communication networks such as long-term evolution (LTE)/fourth generation (4G) network and new radio (NR)/fifth generation (5G) network are expected to achieve high traffic capacity and energy efficiency. In order to meet the diverse requirements of new services across a wide variety of industries, the 3rd generation partnership project (3GPP) is developing various network function services for the communication system architecture (e.g., 5G system (5GS) architecture, etc.) and the policy and charging control framework. This enables flexible network deployment and operation, e.g., by distributed or centralized deployment and the independent scaling between different functions. Considering the diversity of network capabilities and application scenarios, configuration and management of various network services with different QoS requirements may become more challenging.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

Communication networks such as 5G/NR networks are supposed to support the wide range of performance requirements demanded by multiple access technologies, a variety of services and new device types. A terminal device such as user equipment (UE) may roam between different communication networks due to mobility and be provided with various services via network nodes and/or functional entities of the communication networks. In home routed (HR) roaming, a home session management function (H-SMF) may receive QoS constraints (e.g., 5G QoS indicator (5QI), allocation and retention priority (ARP), session aggregate maximum bit rate (AMBR), etc.) from a visit session management function (V-SMF) and provide the received QoS constraints to a home policy control function (H-PCF). The H-PCF may consider the QoS constraints for the setting of the subsequent authorized default 5QI. When the authorized default 5QI is the same as the 5QI provided by the V-SMF, the V-SMF may accept the corresponding protocol data unit (PDU) session. However, according to the existing solutions, the V-SMF only provides one set of visited public land mobile network (VPLMN) QoS data with one vplmn 5QI to the H-SMF. It is very likely that the authorized 5QI by the H-PCF does not match the vplmn 5QI provided by the V-SMF. In this case, the V-SMF may reject the PDU session, resulting in a poor user experience. Therefore, it may be desirable to implement VPLMN QoS handling in a more efficient way.

Various exemplary embodiments of the present disclosure propose a solution for QoS handling, which can enable a list of QoS configuration options (e.g., including a list of vplmnQoS attribute candidates, or a list of 5QI candidates in a vplmnQoS attribute, etc.) for a PDU session to be provided by a VPLMN to a home public land mobile network (HPLMN) based on a roaming agreement between the HPLMN and the VPLMN, so that the HPLMN may have more choices to determine a proper QoS configuration for the PDU session.

According to a first aspect of the present disclosure, there is provided a method performed by a first network node which may be configured to serve a first network (e.g., a HPLMN). The method comprises: receiving a first message transmitted by a second network node serving a second network (e.g., a VPLMN). The first message indicates a list of candidate values provided for a QoS attribute of a session by the second network according to an agreement between the first network and the second network. In accordance with an exemplary embodiment, the method further comprises: obtaining a value for the QoS attribute of the session selected from the list of the candidate values.

In accordance with an exemplary embodiment, the QoS attribute of the session may be associated with a QoS parameter set. In an embodiment, the list of the candidate values for the QoS attribute may correspond to different configurations of the QoS parameter set.

In accordance with an exemplary embodiment, the QoS parameter set may include at least a 5QI.

In accordance with an exemplary embodiment, the QoS attribute of the session may be associated with a QoS parameter.

In accordance with an exemplary embodiment, the QoS parameter may be a 5QI.

In accordance with an exemplary embodiment, the first message may further indicate a maximum allowed value of one or more other QoS parameters.

In accordance with an exemplary embodiment, the first network node may be configured to implement a H-SMF.

In accordance with an exemplary embodiment, the second network node may be configured to implement a V-SMF.

In accordance with an exemplary embodiment, the first message may be a Nsmf_PDUSession_Create Request or a Nsmf_PDUSession_Update Request.

In accordance with an exemplary embodiment, the value for the QoS attribute of the session may be selected from the list of the candidate values by the first network node based at least in part on subscription data related to the session.

In accordance with an exemplary embodiment, the method according to the first aspect of the present disclosure may further comprise: transmitting a second message towards a third network node which is serving the first network and responsible for QoS authorization for the session. In an embodiment, the second message may indicate the selected value for the QoS attribute of the session.

In accordance with an exemplary embodiment, the second message may be a Npcf_SMPolicyControl_Create Request or a Npcf_SMPolicyControl_Update Request.

In accordance with an exemplary embodiment, the method according to the first aspect of the present disclosure may further comprise: transmitting a third message towards a third network node which is serving the first network and responsible for QoS authorization for the session. In an embodiment, the third message may indicate the list of the candidate values for the QoS attribute of the session.

In accordance with an exemplary embodiment, the value for the QoS attribute of the session may be selected from the list of the candidate values by the third network node based at least in part on subscription data related to the session.

In accordance with an exemplary embodiment, the method according to the first aspect of the present disclosure may further comprise: receiving a fourth message transmitted by the third network node. In an embodiment, the fourth message may indicate the selected value for the QoS attribute of the session. In an embodiment, the selected value for the QoS attribute of the session may indicate authorized QoS for the session.

In accordance with an exemplary embodiment, the third message may be a Npcf_SMPolicyControl_Create Request or a Npcf_SMPolicyControl_Update Request.

In accordance with an exemplary embodiment, the fourth message may be a Npcf_SMPolicyControl_Create Response or a Npcf_SMPolicyControl_Update Response.

In accordance with an exemplary embodiment, the third network node may be configured to implement a H-PCF.

In accordance with an exemplary embodiment, the subscription data related to the session may include a 5QI.

In accordance with an exemplary embodiment, the method according to the first aspect of the present disclosure may further comprise: performing QoS authorization for the session by using the selected value for the QoS attribute of the session.

According to a second aspect of the present disclosure, there is provided an apparatus which may be implemented as a first network node. The apparatus may comprise one or more processors and one or more memories storing computer program codes. The one or more memories and the computer program codes may be configured to, with the one or more processors, cause the apparatus at least to perform any step of the method according to the first aspect of the present disclosure.

According to a third aspect of the present disclosure, there is provided a computer-readable medium having computer program codes embodied thereon which, when executed on a computer, cause the computer to perform any step of the method according to the first aspect of the present disclosure.

According to a fourth aspect of the present disclosure, there is provided an apparatus which may be implemented as a first network node. The apparatus may comprise a receiving unit and an obtaining unit. In accordance with some exemplary embodiments, the receiving unit may be operable to carry out at least the receiving step of the method according to the first aspect of the present disclosure. The obtaining unit may be operable to carry out at least the obtaining step of the method according to the first aspect of the present disclosure.

According to a fifth aspect of the present disclosure, there is provided a method performed by a second network node which may be configured to serve a second network (e.g., a VPLMN). The method comprises: determining a list of candidate values for a QoS attribute of a session. The list of the candidate values may be provided by the second network according to an agreement between a first network (e.g., a HPLMN) and the second network. In accordance with an exemplary embodiment, the method further comprises: transmitting a message towards a first network node serving the first network. The message indicates the list of the candidate values for the QoS attribute of the session.

In accordance with an exemplary embodiment, the QoS attribute of the session may be associated with a QoS parameter set, and the list of the candidate values for the QoS attribute may correspond to different configurations of the QoS parameter set. In an embodiment, the QoS parameter set may include at least a 5QI.

In accordance with an exemplary embodiment, the QoS attribute of the session may be associated with a QoS parameter. In an embodiment, the QoS parameter may be a 5QI.

In accordance with an exemplary embodiment, the message may further indicate a maximum allowed value of one or more other QoS parameters.

In accordance with an exemplary embodiment, the first network node may be configured to implement a H-SMF, and the second network node may be configured to implement a V-SMF.

In accordance with an exemplary embodiment, the message may be a Nsmf_PDUSession_Create Request or a Nsmf_PDUSession_Update Request.

According to a sixth aspect of the present disclosure, there is provided an apparatus which may be implemented as a second network node. The apparatus may comprise one or more processors and one or more memories storing computer program codes. The one or more memories and the computer program codes may be configured to, with the one or more processors, cause the apparatus at least to perform any step of the method according to the fifth aspect of the present disclosure.

According to a seventh aspect of the present disclosure, there is provided a computer-readable medium having computer program codes embodied thereon which, when executed on a computer, cause the computer to perform any step of the method according to the fifth aspect of the present disclosure.

According to an eighth aspect of the present disclosure, there is provided an apparatus which may be implemented as a second network node. The apparatus may comprise a determining unit and a transmitting unit. In accordance with some exemplary embodiments, the determining unit may be operable to carry out at least the determining step of the method according to the fifth aspect of the present disclosure. The transmitting unit may be operable to carry out at least the transmitting step of the method according to the fifth aspect of the present disclosure.

According to a ninth aspect of the present disclosure, there is provided a method performed by a third network node which may be configured to serve a first network (e.g., a HPLMN). The method comprises: receiving QoS information transmitted by a first network node serving the first network. The QoS information is related to a list of candidate values provided for a QoS attribute of a session by a second network (e.g., a VPLMN) according to an agreement between the first network and the second network. In accordance with an exemplary embodiment, the method further comprises: obtaining a value for the QoS attribute of the session selected from the list of the candidate values.

In accordance with an exemplary embodiment, the QoS attribute of the session may be associated with a QoS parameter set (which may include at least a 5QI). In an embodiment, the list of the candidate values for the QoS attribute may correspond to different configurations of the QoS parameter set.

In accordance with an exemplary embodiment, the QoS attribute of the session may be associated with a QoS parameter (e.g., a 5QI, etc.).

In accordance with an exemplary embodiment, the first network node may be configured to implement a H-SMF, and the third network node may be configured to implement a H-PCF.

In accordance with an exemplary embodiment, the QoS information may be included in a Npcf_SMPolicyControl_Create Request or a Npcf_SMPolicyControl_Update Request.

In accordance with an exemplary embodiment, the QoS information may include the value for the QoS attribute of the session selected from the list of the candidate values by the first network node based at least in part on subscription data related to the session.

In accordance with an exemplary embodiment, the QoS information may include the list of the candidate values for the QoS attribute of the session.

In accordance with an exemplary embodiment, the value for the QoS attribute of the session may be selected from the list of the candidate values by the third network node based at least in part on subscription data related to the session.

In accordance with an exemplary embodiment, the subscription data related to the session may include a 5QI.

In accordance with an exemplary embodiment, the method according to the ninth aspect of the present disclosure may further comprise: performing QoS authorization for the session by using the selected value for the QoS attribute of the session. In an embodiment, the third network node may authorize QoS for the session based on the selected value.

According to a tenth aspect of the present disclosure, there is provided an apparatus which may be implemented as a third network node. The apparatus may comprise one or more processors and one or more memories storing computer program codes. The one or more memories and the computer program codes may be configured to, with the one or more processors, cause the apparatus at least to perform any step of the method according to the ninth aspect of the present disclosure.

According to an eleventh aspect of the present disclosure, there is provided a computer-readable medium having computer program codes embodied thereon which, when executed on a computer, cause the computer to perform any step of the method according to the ninth aspect of the present disclosure.

According to a twelfth aspect of the present disclosure, there is provided an apparatus which may be implemented as a third network node. The apparatus may comprise a receiving unit and an obtaining unit. In accordance with some exemplary embodiments, the receiving unit may be operable to carry out at least the receiving step of the method according to the ninth aspect of the present disclosure. The obtaining unit may be operable to carry out at least the obtaining step of the method according to the ninth aspect of the present disclosure.

According to various exemplary embodiments, a list of vplmnQoS attribute candidates and/or a vplmnQoS attribute with a list of allowed 5QIs may be provided to a first network node such as a H-SMF by a second network node such as a V-SMF, so that a vplmnQoS attribute with a proper 5QI may be selected for QoS authorization by the first network node or a third network node such as a H-PCF, e.g., based at least in part on subscription data. This can enhance the efficiency and flexibility of VPLMN QoS handling for QoS authorization, especially in HR roaming.

### BRIEF DESCRIPTION OF THE DRAWINGS

The disclosure itself, the preferable mode of use and further objectives are best understood by reference to the following detailed description of the embodiments when read in conjunction with the accompanying drawings, in which:

FIGS. 1A-1B are diagrams illustrating exemplary QoS handling procedures of Solution I according to some embodiments of the present disclosure;

FIG. 2 is a diagram illustrating an exemplary QoS handling procedure of Solution II according to an embodiment of the present disclosure;

FIG. 3 is a flowchart illustrating a method according to an embodiment of the present disclosure;

FIG. 4 is a flowchart illustrating another method according to an embodiment of the present disclosure;

FIG. 5 is a flowchart illustrating yet another method according to an embodiment of the present disclosure;

FIG. 6 is a block diagram illustrating an apparatus according to an embodiment of the present disclosure; and

FIG. 7A-7C are block diagrams illustrating various apparatus according to some embodiments of the present disclosure.

### DETAILED DESCRIPTION

The embodiments of the present disclosure are described in detail with reference to the accompanying drawings. It should be understood that these embodiments are discussed only for the purpose of enabling those skilled persons in the art to better understand and thus implement the present disclosure, rather than suggesting any limitations on the scope of the present disclosure. Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Furthermore, the described features, advantages, and characteristics of the disclosure may be combined in any suitable manner in one or more embodiments. One skilled in the relevant art will recognize that the disclosure may be practiced without one or more of the specific features or advantages of a particular embodiment. In other instances, additional features and advantages may be recognized in certain embodiments that may not be present in all embodiments of the disclosure.

As used herein, the term “communication network” refers to a network following any suitable communication standards, such as new radio (NR), long term evolution (LTE), LTE-Advanced, wideband code division multiple access (WCDMA), high-speed packet access (HSPA), and so on. Furthermore, the communications between a terminal device and a network node in the communication network may be performed according to any suitable generation communication protocols, including, but not limited to, the first generation (1G), the second generation (2G), 2.5G, 2.75G, the third generation (3G), 4G, 4.5G, 5G communication protocols, and/or any other protocols either currently known or to be developed in the future.

As used herein, the terms “first”, “second” and so forth refer to different elements. The singular forms “a” and “an” are intended to include the plural forms as well, unless the context clearly indicates otherwise. The terms “comprises”, “comprising”, “has”, “having”, “includes” and/or “including” as used herein, specify the presence of stated features, elements, and/or components and the like, but do not preclude the presence or addition of one or more other features, elements, components and/or combinations thereof. The term “based on” is to be read as “based at least in part on”. The term “one embodiment” and “an embodiment” are to be read as “at least one embodiment”. The term “another embodiment” is to be read as “at least one other embodiment”. Other definitions, explicit and implicit, may be included below.

VPLMN QoS handling for PDU session establishment in HR roaming is described in clause 4.3.2.2.2 of 3GPP technical specification (TS) 23.502 V17.5.0. In the UE-requested PDU session establishment for HR roaming scenarios as illustrated in FIG. 4.3.2.2.2-1 of 3GPP TS 23.502 V17.5.0, the QoS constraints from a VPLMN are provided by the VPLMN to avoid a risk that a V-SMF rejects a PDU session when controlling service level agreement (SLA) with a HPLMN. If the QoS constraints from the VPLMN is provided, and a PCF is deployed, a H-SMF may provide the QoS constraints from the VPLMN to the PCF. The PCF may take this into account when making policy decisions. In case dynamic policy and charging control (PCC) is not deployed, the H-SMF may take this into account when generating the default QoS rule. When determining whether to accept the PDU session, the V-SMF may apply VPLMN policies related with the SLA negotiated with the HPLMN or with QoS values supported by the VPLMN. Such policies may result in that the V-SMF does not accept the PDU session or does not accept some of the QoS flows requested by the H-SMF. If the V-SMF does not accept the PDU session, the V-SMF may trigger the V-SMF initiated PDU session release procedure, e.g., as defined in clause 4.3.4.3 of 3GPP TS 23.502 V17.5.0.

As described in 3GPP TS 29.502 V17.5.0, the QoS constraints from the VPLMN may be sent by the V-SMF to the H-SMF in an information element (IE) such as vplmnQoS, where one 5QI is included in the vplmnQoS. Table 1 shows the definition of vplmnQoS, and Table 2 lists the QoS constraints (e.g., 5QI, ARP, AMBR, etc.) contained in vplmnQoS.

TABLE 1

| Attribute | | | | | |
|---|---|---|---|---|---|
| name | Data type | P | Cardinality | Description | Applicability |
| vplmnQos | VplmnQos | C | 0 . . . 1 | This IE is present for a HR | VQOS |
| | | | | PDU session, if the V-SMF | |
| | | | | supports the VQOS feature | |
| | | | | and if VPLMN QoS | |
| | | | | constraints are required for | |
| | | | | the PDU session. | |
| | | | | When present, this IE | |
| | | | | contains the QoS constraints | |
| | | | | from the VPLMN. | |

TABLE 2

| Attribute | Data | | | |
|---|---|---|---|---|
| name | type | P | Cardinality | Description |
| 5qi | 5Qi | O | 0 . . . 1 | When present, this IE contains the 5G QoS |
| | | | | Identifier (5QI) accepted or requested for the |
| | | | | QoS Flow associated with the default QoS |
| | | | | rule. |
| arp | Arp | O | 0 . . . 1 | When present, this IE contains the Allocation |
| | | | | and Retention Priority (ARP) accepted by the |
| | | | | VPLMN for the QoS Flow associated with the |
| | | | | default QoS rule. |
| sessionAmbr | Ambr | O | 0 . . . 1 | When present, this IE contains the highest |
| | | | | Session-AMBR accepted by the VPLMN for |
| | | | | the PDU session. |
| maxFbrDl | BitRate | O | 0 . . . 1 | When present, this IE contains the Maximum |
| | | | | Bit Rate in Downlink accepted by the |
| | | | | VPLMN for the QoS Flow associated with the |
| | | | | default QoS rule (if this is a GBR QoS Flow). |
| | | | | See 3GPP TS 23.501 V17.5.0. |
| maxFbrUl | BitRate | O | 0 . . . 1 | When present, this IE contains the Maximum |
| | | | | Bit Rate in Uplink accepted by the VPLMN |
| | | | | for the QoS Flow associated with the default |
| | | | | QoS rule (if this is a GBR QoS Flow). See |
| | | | | 3GPP TS 23.501 V17.5.0. |
| guaFbrDl | BitRate | O | 0 . . . 1 | When present, this IE contains the Guaranteed |
| | | | | Bit Rate in Downlink accepted by the |
| | | | | VPLMN for the QoS Flow associated with the |
| | | | | default QoS rule (if this is a GBR QoS Flow). |
| | | | | See 3GPP TS 23.501 V17.5.0. |
| guaFbrUl | BitRate | O | 0 . . . 1 | This IE contains the Guaranteed Bit Rate in |
| | | | | Uplink accepted by the VPLMN for the QoS |
| | | | | Flow associated with the default QoS rule (if |
| | | | | this is a GBR QoS Flow). See |
| | | | | 3GPP TS 23.501 V17.5.0. |

In HR roaming, the H-SMF may provide the QoS constraints received from the VPLMN (as defined in clause 4.3.2.2.2 of 3GPP TS 23.502 V17.5.0) to the H-PCF. As described in clause 6.1.3.6 of 3GPP TS 23.503 V17.5.0, the H-PCF ensures that the Authorized Session-AMBR value does not exceed the Session-AMBR value provided by the VPLMN and the Authorized default 5QI/ARP contains a 5QI and ARP value supported by the VPLMN. If no QoS constraints are provided, the H-PCF may consider that no QoS constraints apply unless operator policies define any. The H-PCF may also consider the QoS constraints for the setting of the Subsequent Authorized default 5QI/ARP and Subsequent Authorized Session-AMBR.

Global System for Mobile communications Association (GSMA) defines requirements for the VPMN in clause 8.3.2 of GSMA NG.113 V5.0. Control of QoS parameters within the VPMN V-SMF requires QoS profile definition within the roaming agreement and the V-SMF checks any QoS parameters sent by the H-SMF during a PDU session establishment and during a PDU session modification to ensure that they comply to the roaming agreement. A roaming QoS profile in the V-SMF may be defined by a list of allowed 5QIs (guaranteed bit rate (GBR) and non-GBR) and a remapping matrix for non-GBR 5QI (including 5QI 5).

According to the contents in clause 4.7.2.1 of 3GPP TS 23.401 V17.5.0, the initial bearer level QoS parameter values of the default bearer are assigned by the network, based on subscription data (in an evolved universal terrestrial radio access network (E-UTRAN), a mobility management entity (MME) may set those initial values based on subscription data retrieved from a home subscriber server (HSS)).

In a roaming scenario, based on local configuration, the MME may downgrade the ARP or APN-AMBR and/or remap QoS class identifier (QCI) parameter values received from the HSS to the value locally configured in the MME (e.g., when the values received from the HSS do not comply with services provided by the visited PLMN). The policy and charging enforcement function (PCEF) may change the QoS parameter values received from the MME based on interaction with the policy and charging rules function (PCRF) or based on local configuration. Alternatively, the PCEF may reject the bearer establishment.

It is noted that for certain access point names (APNs), e.g., the Internet protocol multimedia subsystem (IMS) APN defined by the GSMA, the QCI value is strictly defined and therefore remapping of QCI is not permitted. In addition, in roaming scenarios, the ARP/APN-AMBR/QCI values provided by the MME for a default bearer may deviate from the subscribed values depending on the roaming agreement. If the PCC/PCEF rejects the establishment of the default bearer, this implies that Attach via E-UTRAN will fail. Similarly, if the PCEF (based on interaction with the PCRF or based on local configuration) upgrades the ARP/APN-AMBR/QCI parameter values received from the MME, the default bearer establishment and attach may be rejected by the MME.

3GPP TS 23.501 V17.5.0 describes standardized 5QI to QoS characteristics mapping in clause 5.7.4. Standardized 5QI values may be specified for services that are assumed to be frequently used and thus benefit from optimized signaling by using standardized QoS characteristics. Dynamically assigned 5QI values (which may require signaling of QoS characteristics as part of the QoS profile) can be used for services for which standardized 5QI values are not defined. The one-to-one mapping of standardized 5QI values to 5G QoS characteristics is specified in Table 5.7.4-1 of 3GPP TS 23.501 V17.5.0.

In evolved packet system (EPS) HR roaming, an MME can provide different VPLMN QoS data to a HPLMN/PCRF for QoS authorization based on the inbound roamer's subscription data. It may be required by customers, e.g., different QoS constraints per QCI group required by some customer. This assures that the VPLMN QoS data sent from the MME to the HPLMN may be aligned with the subscription QoS in the HPLMN HSS.

In 5GS, a V-SMF may not achieve the QoS data alignment as mentioned above, as the V-SMF has no interface to a unified data management (UDM) entity. In addition, the V-SMF can only send one set of VPLMN QoS data with one 5QI to a H-SMF/H-PCF (e.g., according to 3GPP TS 29.502 V17.5.0). For a PDU session, it is required that the authorized 5QI by the H-PCF or the H-SMF needs to be the same as the VPLMN 5QI provided by the V-SMF; otherwise, the V-SMF may reject the PDU session.

For the current 3GPP solutions, there may be the following issues:
It may increase the risk of PDU session failure. Based on the requirements from some customers, if the authorized 5QI is different from the VPLMN 5QI provided by the V-SMF, the V-SMF may reject the PDU session.
It may not provide the same function (e.g., the QCI based on VPLMN QoS policy) as that provided by the MME for customers.
It may also cause a bad user experience as only one configuration of VPLMN QoS is provided by the V-SMF per HPLMN/DNN, and a user's subscription data may not be considered by the V-SMF. For different users, the default 5QI for a specific data network name (DNN) may be different and different 5QIs may have different QoS characteristics (e.g., as described in Table 5.7.4-1 of 3GPP TS 23.501 V17.5.0).

In order to address one or more issues mentioned above, various exemplary embodiments of the present disclosure propose solutions to enable a list of vplmnQoS attribute candidates or a list of allowed 5QIs in a vplmnQoS attribute to be configured per HPLMN/DNN, e.g., in a V-SMF based on a roaming agreement between VPLMN and HPLMN operators.

In accordance with an exemplary embodiment, a V-SMF may provide, e.g., in PDU session setup, a list of “N” vplmnQoS attribute candidates to a H-SMF, where N is an integer equal to or larger than 2. Table 3 shows the list of “N” vplmnQoS attribute candidates sent from the V-SMF to the H-SMF. Compared to Table 1, the cardinality of vplmnQoS attribute in Table 3 is changed from “0 . . . 1” to “0 . . . . N”. In an embodiment, the QoS constraints (e.g., 5QI, ARP, AMBR, etc.) contained in a vplmnQoS attribute may be the same as those shown in Table 2, where the cardinality of 5QI attribute is “0 . . . 1”. In another embodiment, for at least one vplmnQoS attribute candidate among the list of vplmnQoS attribute candidates, the cardinality of 5QI attribute associated with the at least one vplmnQoS attribute candidate may be set to “0 . . . M” to indicate a list of “M” allowed 5QIs, as shown in Table 4.

TABLE 3

| Attribute | Data | | | | |
|---|---|---|---|---|---|
| name | type | P | Cardinality | Description | Applicability |
| vplmnQos | VplmnQos | C | 0 . . . N | This IE is present for a HR PDU | VQOS |
| | | | | session, if the V-SMF supports | |
| | | | | the VQOS feature and if | |
| | | | | VPLMN QoS constraints are | |
| | | | | required for the PDU session. | |
| | | | | When present, this IE contains | |
| | | | | the QoS constraints from the | |
| | | | | VPLMN. | |

In accordance with an exemplary embodiment, a V-SMF may provide, e.g., in PDU session setup, a list of “M” allowed 5QI candidates in a vplmnQoS attribute to a H-SMF, where M is an integer equal to or larger than 2. Table 4 shows the list of “M” allowed 5QIs in the vplmnQoS attribute sent from the V-SMF to the H-SMF. Compared to Table 2, the cardinality of 5QI attribute in Table 4 is changed from “0 . . . 1” to “0 . . . . M”. In an embodiment, the vplmnQoS attribute containing the list of “M” allowed 5QIs and other QoS constraints (e.g., ARP, AMBR, etc.) may be the same as that shown in Table 1, where the cardinality of vplmnQoS attribute is “0 . . . 1”.

TABLE 4

| Attribute | | | Cardinal- | |
|---|---|---|---|---|
| name | Data type | P | ity | Description |
| 5qi | 5Qi | O | 0 . . . M | When present, this IE contains the 5G QoS |
| | | | | Identifier (5QI) accepted or requested for the |
| | | | | QoS Flow associated with the default QoS |
| | | | | rule. |
| arp | Arp | O | 0 . . . 1 | When present, this IE contains the Allocation |
| | | | | and Retention Priority (ARP) accepted by the |
| | | | | VPLMN for the QoS Flow associated with the |
| | | | | default QoS rule. |
| sessionAmbr | Ambr | O | 0 . . . 1 | When present, this IE contains the highest |
| | | | | Session-AMBR accepted by the VPLMN for |
| | | | | the PDU session. |
| maxFbrDl | BitRate | O | 0 . . . 1 | When present, this IE contains the Maximum |
| | | | | Bit Rate in Downlink accepted by the |
| | | | | VPLMN for the QoS Flow associated with the |
| | | | | default QoS rule (if this is a GBR QoS Flow). |
| | | | | See 3GPP TS 23.501 V17.5.0. |
| maxFbrUl | BitRate | O | 0 . . . 1 | When present, this IE contains the Maximum |
| | | | | Bit Rate in Uplink accepted by the VPLMN |
| | | | | for the QoS Flow associated with the default |
| | | | | QoS rule (if this is a GBR QoS Flow). See |
| | | | | 3GPP TS 23.501 V17.5.0. |
| guaFbrDl | BitRate | O | 0 . . . 1 | When present, this IE contains the Guaranteed |
| | | | | Bit Rate in Downlink accepted by the |
| | | | | VPLMN for the QoS Flow associated with the |
| | | | | default QoS rule (if this is a GBR QoS Flow). |
| | | | | See 3GPP TS 23.501 V17.5.0. |
| guaFbrUl | BitRate | O | 0 . . . 1 | This IE contains the Guaranteed Bit Rate in |
| | | | | Uplink accepted by the VPLMN for the QoS |
| | | | | Flow associated with the default QoS rule (if |
| | | | | this is a GBR QoS Flow). See |
| | | | | 3GPP TS 23.501 V17.5.0. |

In accordance with exemplary embodiments, there may be two VPLMN QoS handling solutions for QoS authorization in HR roaming:
Solution I: A H-SMF may receive user subscription data from a database such as UDM or obtain the locally stored user subscription data, and based on the 5QI included in the user subscription data, the H-SMF may select a vplmnQoS attribute and/or a 5QI from the VPLMN QoS data obtained from a V-SMF.
   If a list of vplmnQoS attribute candidates is sent from the V-SMF to the H-SMF, the H-SMF may select a vplmnQoS attribute from the list of vplmnQoS attribute candidates and send the selected vplmnQoS attribute to a H-PCF for QoS authorization.
   If a vplmnQoS attribute with a list of allowed 5QIs is sent by the V-SMF to the H-SMF, the H-SMF may select a 5QI from the list of allowed 5QIs in the vplmnQoS attribute and send the selected 5QI to the H-PCF for QoS authorization.
Solution II: A H-SMF may transparently send the VPLMN QoS data (e.g., including a list of vplmnQoS attribute candidates or a list of allowed 5QIs in a vplmnQoS attribute) received from a V-SMF to a H-PCF, and then the H-PCF may take the VPLMN QoS data into account when performing the QoS authorization.

In accordance with an exemplary embodiment, in case dynamic PCC is not deployed, a H-SMF may take the VPLMN QoS data into account when authorizing the QoS based on a local policy.

It can be appreciated that the proposed solutions may be extended to other scenarios when a V-SMF sends the VPLMN QoS data to a H-SMF for QoS authorization, e.g., for the cases of the V-SMF change, the new V-SMF and 4G5G interworking (IWK), etc.

Many advantages may be achieved by applying the proposed solutions. For example, it may be feasible for the VPLMN QoS data sent to the HPLMN to differentiate a user's subscription data, enabling the VPLMN and the HPLMN to have roaming agreements with fine granularity. It can reduce the risk of PDU session setup failure and also the failure of other procedures in which a V-SMF may send the VPLMN QoS data to a H-SMF (e.g., in the case of V-SMF change/insertion, 4G to 5G mobility, etc.), as a list of allowed vplmnQoS attributes and/or a list of allowed 5QIs can be provided to the HPLMN, making the HPLMN have more choices. With the proposed solutions, the 5G core (5GC) can provide the same or similar function (e.g., different VPLMN QoS policies based on a QCI group) to a customer as an EPS/MME offers today. In addition, the proposed solutions can also create a better user experience as VPLMN QoS policy control is based on the inbound roamer's subscription in the HPLMN. The differentiated services in the user's HPLMN subscription can be applied for various HR roaming scenarios.

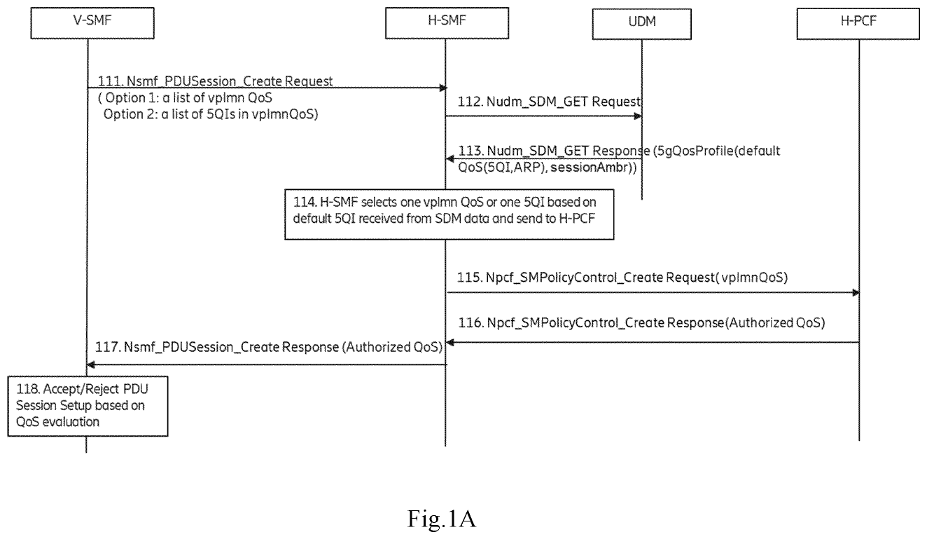

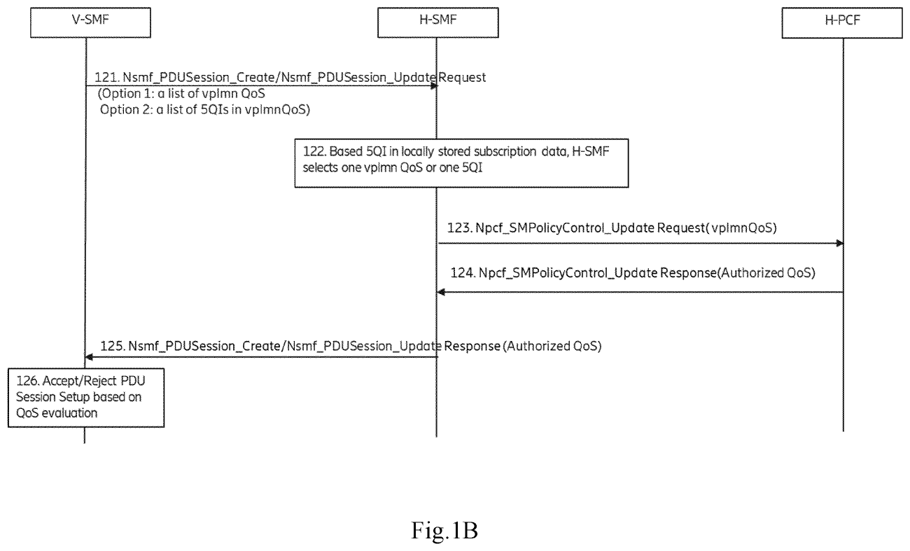

FIGS. 1A-1B are diagrams illustrating exemplary QoS handling procedures of Solution I according to some embodiments of the present disclosure. According to Solution I, per HPLMN/DDN, a V-SMF may get or configure a list of vplmnQoS attribute candidates or a vplmnQoS attribute with a list of allowed 5QIs in locally configured VPLMN QoS constraints. In a PDU session procedure (e.g., a PDU session setup procedure), the V-SMF may send the list of vplmnQoS attribute candidates or the list of allowed 5QIs in a vplmnQoS attribute to a H-SMF. In an embodiment, if the V-SMF sends the list of allowed 5QIs in the vplmnQoS attribute to the H-SMF, the V-SMF may inform the H-SMF of the highest allowed bandwidth in other QoS constraints such as SessionAmbr, maxFbrDl, maxFbrUl, guaFbrDl and guaFbrUl. Based on the default 5QI in subscriber data management (SDM) data, the H-SMF may select/map one vplmnQoS attribute or one 5QI from the corresponding list provided by the V-SMF and include the selection/mapping result in the vplmnQoS attribute to send it to a H-PCF for QoS authorization.

In accordance with exemplary embodiments, the above QoS handling according to Solution I may be applicable to various scenarios, for example, in initial PDU session setup or other PDU session procedures with Nudm_SDM_Get (e.g., 4G mobility to 5G with Nudm_SDM_GET operation) as shown in FIG. 1A, in V-SMF change/insert or other cases without Nudm_SDM_Get (e.g., 4G to 5G mobility without Nudm_SDM_GET operation) as shown in FIG. 1B, etc.

In the scenario of FIG. 1A, a V-SMF may send 111 a list of vplmnQoS attribute candidates (also called a vplmnQoS list) or a list of allowed 5QIs (also called a vplmn5QI list) in a vplmnQoS attribute to a H-SMF, e.g., via a Nsmf_PDUSession_Create Request. The V-SMF can map the locally configured 5QIs based on HPLMN. The mapped 5QIs may be sent to the H-SMF by the V-SMF. The H-SMF may send 112 a Nudm_SDM_GET Request to a UDM to retrieve a user's subscription data. Then the H-SMF may receive 113 the user's subscription data with default QoS (e.g., 5QI, ARP, etc.) in a Nudm_SDM_GET Response from the UDM. Based on the 5QI received from the UDM, the H-SMF may select 114 one vplmnQoS attribute from the vplmnQoS list sent by the V-SMF, and/or select 114 one 5QI from the vplmn5QI list provided by the V-SMF. In order to authorize the QoS, the H-SMF may send 115 the selected vplmnQoS attribute and/or the selected 5QI in the vplmnQoS attribute to the H-PCF, e.g., in a Npcf_SMPolicyControl_Create Request. The H-PCF may use the QoS data (e.g., including the selected vplmnQoS attribute and/or the selected 5QI, etc.) received from the H-SMF to authorize the QoS and send 116 the authorized QoS (e.g., including the authorized 5QI, etc.) to the H-SMF, e.g., in a Npcf_SMPolicyControl_Create Response. Then the H-SMF may send 117 the authorized QoS (e.g., including the authorized 5QI, etc.) to the V-SMF, e.g., in a Nsmf_PDUSession_Create Response. The V-SMF may check the authorized 5QI in the vplmnQoS attribute received from the H-SMF to evaluate the authorized QoS. Based on the QoS evaluation, the V-SMF may determine 118 whether to accept or reject the PDU session setup. For example, if the authorized 5QI belongs to the allowed vplmn5QIs, the V-SMF may continue the procedure; otherwise, the V-SMF may reject the procedure.

In the scenario of FIG. 1B, e.g., for the cases of V-SMF change/insert, or other cases without UDM interaction in SMF, a V-SMF may send 121 a list of vplmnQoS attribute candidates (also called a vplmnQoS list) or a list of allowed 5QIs (also called a vplmn5QI list) in a vplmnQoS attribute to a H-SMF, e.g., via a Nsmf_PDUSession_Create/Update Request. The V-SMF can map the locally configured 5QIs based on HPLMN. The mapped 5QIs may be sent to the H-SMF by the V-SMF. Compared to the scenario of FIG. 1A, the H-SMF in the scenario of FIG. 1B has the locally stored subscription data and thus may not need to retrieve a user's subscription data from a UDM. Based on the 5QI in the locally stored subscription data, the H-SMF may select 122 one vplmnQoS attribute from the vplmnQoS list sent by the V-SMF, and/or select 122 one 5QI from the vplmn5QI list provided by the V-SMF. The H-SMF may send 123 the selected vplmnQoS attribute and/or the selected 5QI in the vplmnQoS attribute to the H-PCF, e.g., in a Npcf_SMPolicyControl_Update Request. The H-PCF may use the QoS data (e.g., including the selected vplmnQoS attribute and/or the selected 5QI, etc.) received from the H-SMF to re-authorize the QoS, and send 124 the re-authorized QoS (e.g., including the re-authorized 5QI, etc.) to the H-SMF in a Npcf_SMPolicyControl_Update Response if it changes compared to the previously authorized one. Then the H-SMF may send 125 the re-authorized QoS (e.g., including the re-authorized 5QI, etc.) to the V-SMF, e.g., in a Nsmf_PDUSession_Create/Update Response. The V-SMF may check the re-authorized 5QI in the vplmnQoS attribute received from the H-SMF to evaluate the re-authorized QoS. Based on the QoS evaluation, the V-SMF may determine 126 whether to accept or reject the PDU session setup. For example, if the re-authorized 5QI received from the H-SMF belongs to the allowed vplmn5QIs, the V-SMF may continue the procedure; otherwise, the V-SMF may reject the procedure.

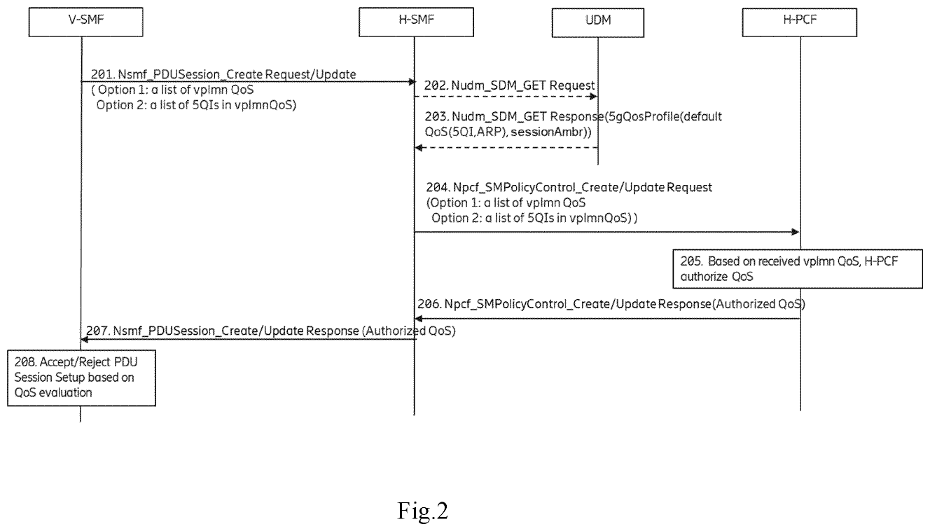

FIG. 2 is a diagram illustrating an exemplary QoS handling procedure of Solution II according to an embodiment of the present disclosure. According to Solution II, per HPLMN/DDN, a V-SMF may get or configure a list of vplmnQoS attribute candidates or a vplmnQoS attribute with a list of allowed 5QIs in locally configured VPLMN QoS constraints. In a PDU session procedure (e.g., a PDU session setup procedure), the V-SMF may send the list of vplmnQoS attribute candidates or the list of allowed 5QIs in a vplmnQoS attribute to a H-SMF. In an embodiment, if the V-SMF sends the list of allowed 5QIs in the vplmnQoS attribute to the H-SMF, the V-SMF may inform the H-SMF of the highest allowed bandwidth in other QoS constraints such as SessionAmbr, maxFbrDl, maxFbrUl, guaFbrDI and guaFbrUl. Different from Solution I where the H-SMF may select one vplmnQoS attribute or one 5QI from the corresponding list provided by the V-SMF, in Solution II, the H-SMF may transparently send the VPLMN QoS data received from the V-SMF to a H-PCF. Based on the subscribed default QoS and the received VPLMN QoS data from the H-SMF, the H-PCF may authorize the QoS for the PDU session.

In accordance with exemplary embodiments, the above QoS handling according to Solution II may be applicable to various scenarios, for example, in initial PDU session setup or other PDU session procedures with Nudm_SDM_Get (e.g., 4G mobility to 5G with Nudm_SDM_GET operation), in V-SMF change/insert or other cases without Nudm_SDM_Get (e.g., 4G to 5G mobility without Nudm_SDM_GET operation), etc.

In the scenarios of FIG. 2, a V-SMF may send 201 a list of vplmnQoS attribute candidates (also called a vplmnQoS list) or a list of allowed 5QIs (also called a vplmn5QI list) in a vplmnQoS attribute to a H-SMF, e.g., via a Nsmf_PDUSession_Create/Update Request. The V-SMF can map the locally configured 5QIs based on HPLMN. The mapped 5QIs may be sent to the H-SMF by the V-SMF. In an embodiment, the H-SMF may optionally send 202 a Nudm_SDM_GET Request to a UDM to retrieve a user's subscription data. Then the H-SMF may optionally receive 203 the user's subscription data with the default QoS (e.g., 5QI, ARP, etc.) in a Nudm_SDM_GET Response from the UDM. In another embodiment, the H-SMF may have the locally stored subscription data, without retrieving the user's subscription data from the UDM. According to the procedure shown in FIG. 2, the H-SMF may send 204 the vplmnQoS list and/or the vplmn5QI list to a H-PCF, e.g., in a Npcf_SMPolicyControl_Create/Update Request. Taking the VPLMN QoS data (e.g., including the vplmnQoS list and/or the vplmn5QI list, etc.) received from the H-SMF into account, the H-PCF may authorize 205 the QoS for the PDU session. For example, the H-PCF may select one vplmnQoS attribute with a 5QI from the vplmnQoS list, and/or one 5Q1 from the vplmn5QI list, based on the subscription data. Then the H-PCF may send 206 the authorized QoS (e.g., including the authorized 5QI, etc.) to the H-SMF, e.g., in a Npcf_SMPolicyControl_Create/Update Response. The H-SMF may send 207 the authorized QoS (e.g., including the authorized 5QI, etc.) to the V-SMF, e.g., in a Nsmf_PDUSession_Create/Update Response. The V-SMF may check the authorized 5QI in the vplmnQoS attribute received from the H-SMF to evaluate the authorized QoS. Based on the QoS evaluation, the V-SMF may determine 208 whether to accept or reject the PDU session setup. For example, if the authorized 5QI belongs to the allowed vplmn5QIs, the V-SMF may continue the procedure; otherwise, the V-SMF may reject the procedure.

It can be appreciated that network elements and signaling messages shown in FIG. 1A, FIG. 1B and FIG. 2 are just as examples, and more or less alternative network elements and signaling messages may be involved in the QoS handling procedure according to various embodiments of the present disclosure.

According to the QoS handling procedures in various exemplary embodiments, a H-SMF may adopt different solutions to process the VPLMN QoS data per HPLMN/DNN (e.g., including a list of vplmnQoS attribute candidates, or one vplmnQoS attribute with a list of allowed 5QIs, etc.) received from a V-SMF. When adopting Solution I, the H-SMF may select one vplmnQoS attribute with a 5QI from the list of vplmnQoS attribute candidates, or select one 5QI from the list of allowed 5QIs, e.g., based on the 5QI in the subscription data which may be stored at the H-SMF or obtained from a UDM. Then the H-SMF may send the selected vplmnQoS/5QI to a H-PCF so that the H-PCF can authorize the vplmnQoS with 5QI accordingly. When adopting Solution II, the H-SMF may transparently send the VPLMN QoS data received from the V-SMF to the H-PCF, and then the H-PCF may take the VPLMN QoS data into account and authorize the QoS for a PDU session accordingly. In an embodiment, the H-SMF may not send the VPLMN QoS data to the H-PCF (e.g., in the case that dynamic PCC is not deployed), but use the VPLMN QoS data to authorize the QoS for the PDU session based on a local policy.

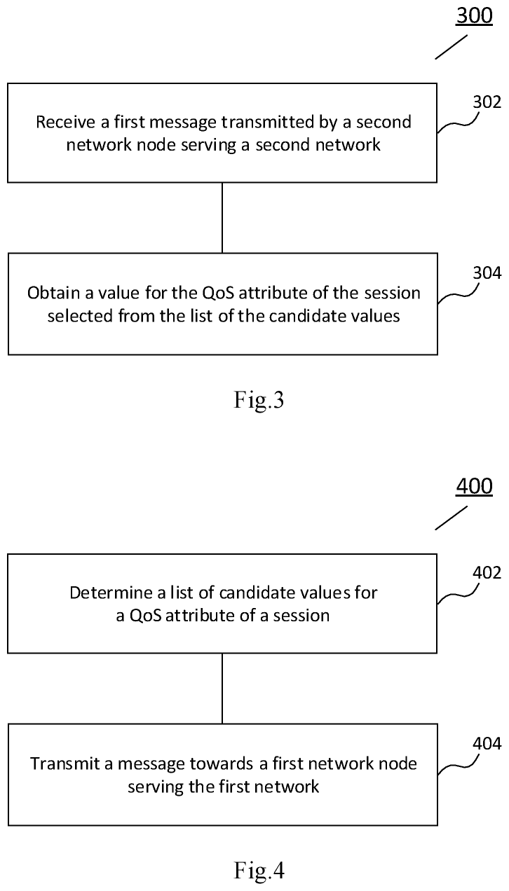

FIG. 3 is a flowchart illustrating a method 300 according to some embodiments of the present disclosure. The method 300 illustrated in FIG. 3 may be performed by a first network node or an apparatus communicatively coupled to the first network node. In accordance with an exemplary embodiment, the first network node may be configured to serve a first network (e.g., a HPLMN). In accordance with another exemplary embodiment, the first network node may be configured to implement a H-SMF or act as any other suitable network entity which may be configured to perform session management for a terminal device (e.g., a UE, etc.) in a HPLMN.

According to the exemplary method 300 illustrated in FIG. 3, the first network node may receive a first message transmitted by a second network node serving a second network (e.g., a VPLMN), as shown in block 302. In an embodiment, the second network node may be configured to implement a V-SMF. In accordance with an exemplary embodiment, the first message may indicate a list of candidate values provided for a QoS attribute of a session by the second network according to an agreement (e.g., a roaming agreement, etc.) between the first network and the second network. In an embodiment, the number of candidate values for the QoS attribute of the session may be related to the granularity of the agreement between the first network and the second network, e.g., the finer the granularity, the more candidate values. In accordance with an exemplary embodiment, the first network node may obtain a value for the QoS attribute of the session selected from the list of the candidate values, as shown in block 304.

In accordance with an exemplary embodiment, the QoS attribute (e.g., the vplmnQoS attribute as shown in Table 3, etc.) of the session may be associated with a QoS parameter set (e.g., the QoS constraint set including 5QI, ARP, AMBR, etc. which are contained in the vplmnQoS attribute). The list of the candidate values (e.g., corresponding to the cardinality “0 . . . . N” of the vplmnQoS attribute in Table 3) for the QoS attribute may correspond to different configurations of the QoS parameter set. In an embodiment, the QoS parameter set may include at least a 5QI.

In accordance with an exemplary embodiment, the QoS attribute (e.g., the 5QI attribute as shown in Table 4, etc.) of the session may be associated with a QoS parameter. The list of the candidate values (e.g., corresponding to the cardinality “0 . . . . M” of the 5QI attribute in Table 4) for the QoS attribute may correspond to different configurations of the QoS parameter. In an embodiment, the QoS parameter may be a 5QI.

In accordance with an exemplary embodiment, the first message may further indicate a maximum allowed value of one or more other QoS parameters (e.g., SessionAmbr, maxFbrDl, maxFbrUl, guaFbrDl and guaFbrUl, etc.). In an embodiment, the first message may be a Nsmf_PDUSession_Create Request or a Nsmf_PDUSession_Update Request.

In accordance with an exemplary embodiment, the value for the QoS attribute of the session may be selected from the list of the candidate values by the first network node based at least in part on subscription data related to the session. In an embodiment, the subscription data related to the session may include a 5QI.

In accordance with an exemplary embodiment, the first network node may transmit a second message (e.g., a Npcf_SMPolicyControl_Create Request or a Npcf_SMPolicyControl_Update Request, etc.) towards a third network node which is serving the first network and responsible for QoS authorization for the session. The second message may indicate the selected value for the QoS attribute of the session. In an embodiment, the third network node may be configured to implement a H-PCF.

In accordance with an exemplary embodiment, the first network node may transmit a third message (e.g., a Npcf_SMPolicyControl_Create Request or a Npcf_SMPolicyControl_Update Request, etc.) towards the third network node which is serving the first network and responsible for QoS authorization for the session. The third message may indicate the list of the candidate values for the QoS attribute of the session.

In accordance with an exemplary embodiment, the value for the QoS attribute of the session may be selected from the list of the candidate values by the third network node based at least in part on subscription data (e.g., including 5QI, etc.) related to the session.

In accordance with an exemplary embodiment, the first network node may receive a fourth message (e.g., a Npcf_SMPolicyControl_Create Response or a Npcf_SMPolicyControl_Update Response, etc.) transmitted by the third network node. The fourth message may indicate the selected value for the QoS attribute of the session. In an embodiment, the selected value for the QoS attribute of the session may indicate authorized QoS for the session.

In accordance with an exemplary embodiment, the first network node may perform QoS authorization for the session by using the selected value for the QoS attribute of the session. For example, in case dynamic PCC is not deployed, the first network node such as a H-SMF may not send QoS information (e.g., information about the list of the candidate values) received from the second network node such as a V-SMF to the third network node such as a H-PCF, but select a value for the QoS attribute of the session from the list of the candidate values and use the selected value to authorize QoS for the session based on a local policy.

FIG. 4 is a flowchart illustrating a method 400 according to some embodiments of the present disclosure. The method 400 illustrated in FIG. 4 may be performed by a second network node or an apparatus communicatively coupled to the second network node. In accordance with an exemplary embodiment, the second network node may be configured to serve a second network (e.g., a VPLMN). In accordance with another exemplary embodiment, the second network node may be configured to implement a V-SMF or act as any other suitable network entity which may be configured to perform session management for a terminal device (e.g., a UE, etc.) in a VPLMN.

According to the exemplary method 400 illustrated in FIG. 4, the second network node may determine a list of candidate values for a QoS attribute of a session, as shown in block 402. The list of the candidate values may be provided by the second network according to an agreement (e.g., a roaming agreement, etc.) between a first network (e.g., a HPLMN) and the second network. In accordance with an exemplary embodiment, the second network node may transmit a message (e.g., the first message as described with respect to FIG. 3) towards a first network node (e.g., the first network node as described with respect to FIG. 3) serving the first network, as shown in block 404. The message may indicate the list of the candidate values for the QoS attribute of the session. In an embodiment, the message may be a Nsmf_PDUSession_Create Request or a Nsmf_PDUSession_Update Request.

In accordance with an exemplary embodiment, the list of the candidate values for the QoS attribute of the session according to the method 400 may correspond to the list of the candidate values for the QoS attribute of the session according to the method 300. Thus, the list of the candidate values for the QoS attribute of the session as described with respect to FIG. 3 and FIG. 4 may have the same or similar contents and/or feature elements.

In accordance with an exemplary embodiment, the QoS attribute of the session may be associated with a QoS parameter set (e.g., including at least a 5QI), and the list of the candidate values for the QoS attribute may correspond to different configurations of the QoS parameter set. In accordance with another exemplary embodiment, the QoS attribute of the session may be associated with a QoS parameter (e.g., a 5QI, etc.).

In accordance with an exemplary embodiment, the message transmitted by the second network node (e.g., a V-SMF, etc.) towards the first network node (e.g., a H-SMF, etc.) may further indicate a maximum allowed value of one or more other QoS parameters (e.g., SessionAmbr, maxFbrDl, maxFbrUl, guaFbrDl and guaFbrUl, etc.).

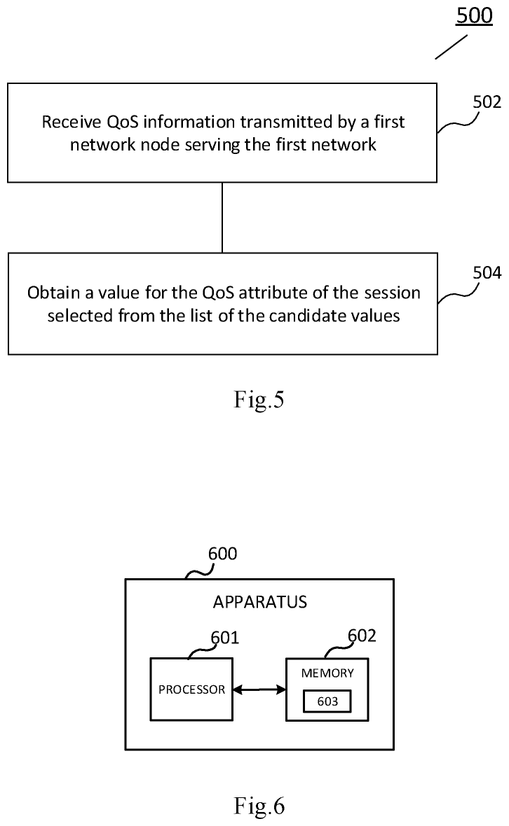

FIG. 5 is a flowchart illustrating a method 500 according to some embodiments of the present disclosure. The method 500 illustrated in FIG. 5 may be performed by a third network node or an apparatus communicatively coupled to the third network node. In accordance with an exemplary embodiment, the third network node may be configured to serve a first network (e.g., a HPLMN). In accordance with another exemplary embodiment, the third network node may be configured to implement a H-PCF or act as any other suitable network entity which may be configured to perform policy control in a HPLMN.

According to the exemplary method 500 illustrated in FIG. 5, the third network node may receive QoS information transmitted by a first network node (e.g., the first network node as described with respect to FIG. 3) serving the first network, as shown in block 502. The QoS information may be related to a list of candidate values provided for a QoS attribute of a session by a second network (e.g., a VPLMN) according to an agreement (e.g., a roaming agreement, etc.) between the first network and the second network. In accordance with an exemplary embodiment, the third network node may obtain a value for the QoS attribute of the session selected from the list of the candidate values, as shown in block 504.

In accordance with an exemplary embodiment, the list of the candidate values for the QoS attribute of the session according to the method 500 may correspond to the list of the candidate values for the QoS attribute of the session according to the method 300. Thus, the list of the candidate values for the QoS attribute of the session as described with respect to FIG. 3 and FIG. 5 may have the same or similar contents and/or feature elements.

In accordance with an exemplary embodiment, the QoS attribute of the session may be associated with a QoS parameter set (e.g., include at least a 5QI), and the list of the candidate values for the QoS attribute may correspond to different configurations of the QoS parameter set. In accordance with another exemplary embodiment, the QoS attribute of the session may be associated with a QoS parameter (e.g., a 5QI, etc.).

In accordance with an exemplary embodiment, the QoS information may be included in a Npcf_SMPolicyControl_Create Request or a Npcf_SMPolicyControl_Update Request.

In accordance with an exemplary embodiment, the QoS information may include the value for the QoS attribute of the session selected from the list of the candidate values by the first network node based at least in part on subscription data (e.g., including a 5QI, etc.) related to the session.

In accordance with an exemplary embodiment, the QoS information may include the list of the candidate values for the QoS attribute of the session. In an embodiment, the value for the QoS attribute of the session may be selected from the list of the candidate values by the third network node based at least in part on subscription data (e.g., including a 5QI, etc.) related to the session.

In accordance with an exemplary embodiment, the third network node may perform QoS authorization for the session by using the selected value for the QoS attribute of the session. In an embodiment, the third network node may authorize QoS for the session based on the selected value.

The various blocks shown in FIGS. 3-5 may be viewed as method steps, and/or as operations that result from operation of computer program code, and/or as a plurality of coupled logic circuit elements constructed to carry out the associated function(s). The schematic flow chart diagrams described above are generally set forth as logical flow chart diagrams. As such, the depicted order and labeled steps are indicative of specific embodiments of the presented methods. Other steps and methods may be conceived that are equivalent in function, logic, or effect to one or more steps, or portions thereof, of the illustrated methods. Additionally, the order in which a particular method occurs may or may not strictly adhere to the order of the corresponding steps shown.

It can be appreciated that the network node and/or the network entity according to various embodiments can be implemented either as a network element on a dedicated hardware, as a software instance running on a dedicated hardware, or as a virtualized function instantiated on an appropriate platform, e.g., on a cloud infrastructure.

FIG. 6 is a block diagram illustrating an apparatus 600 according to various embodiments of the present disclosure. As shown in FIG. 6, the apparatus 600 may comprise one or more processors such as processor 601 and one or more memories such as memory 602 storing computer program codes 603. The memory 602 may be non-transitory machine/processor/computer readable storage medium. In accordance with some exemplary embodiments, the apparatus 600 may be implemented as an integrated circuit chip or module that can be plugged or installed into a first network node as described with respect to FIG. 3, or a second network node as described with respect to FIG. 4, or a third network node as described with respect to FIG. 5. In such cases, the apparatus 600 may be implemented as a first network node as described with respect to FIG. 3, or a second network node as described with respect to FIG. 4, or a third network node as described with respect to FIG. 5.

In some implementations, the one or more memories 602 and the computer program codes 603 may be configured to, with the one or more processors 601, cause the apparatus 600 at least to perform any operation of the method as described in connection with FIG. 3. In other implementations, the one or more memories 602 and the computer program codes 603 may be configured to, with the one or more processors 601, cause the apparatus 600 at least to perform any operation of the method as described in connection with FIG. 4. In other implementations, the one or more memories 602 and the computer program codes 603 may be configured to, with the one or more processors 601, cause the apparatus 600 at least to perform any operation of the method as described in connection with FIG. 5. Alternatively or additionally, the one or more memories 602 and the computer program codes 603 may be configured to, with the one or more processors 601, cause the apparatus 600 at least to perform more or less operations to implement the proposed methods according to the exemplary embodiments of the present disclosure.

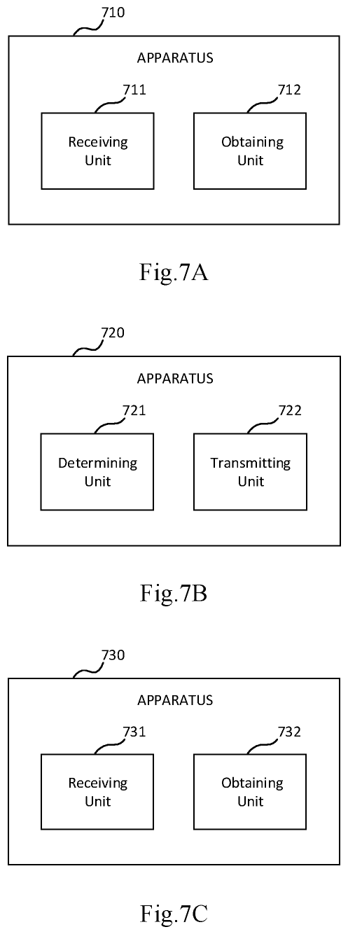

FIG. 7A is a block diagram illustrating an apparatus 710 according to some embodiments of the present disclosure. As shown in FIG. 7A, the apparatus 710 may comprise a receiving unit 711 and an obtaining unit 712. In an exemplary embodiment, the apparatus 710 may be implemented in a first network node (e.g., a H-SMF, etc.). The receiving unit 711 may be operable to carry out the operation in block 302, and the obtaining unit 712 may be operable to carry out the operation in block 304. Optionally, the receiving unit 711 and/or the obtaining unit 712 may be operable to carry out more or less operations to implement the proposed methods according to the exemplary embodiments of the present disclosure.

FIG. 7B is a block diagram illustrating an apparatus 720 according to some embodiments of the present disclosure. As shown in FIG. 7B, the apparatus 720 may comprise a determining unit 721 and a transmitting unit 722. In an exemplary embodiment, the apparatus 720 may be implemented in a second network node (e.g., a V-SMF, etc.). The determining unit 721 may be operable to carry out the operation in block 402, and the transmitting unit 722 may be operable to carry out the operation in block 404. Optionally, the determining unit 721 and/or the transmitting unit 722 may be operable to carry out more or less operations to implement the proposed methods according to the exemplary embodiments of the present disclosure.

FIG. 7C is a block diagram illustrating an apparatus 730 according to some embodiments of the present disclosure. As shown in FIG. 7C, the apparatus 730 may comprise a receiving unit 731 and an obtaining unit 732. In an exemplary embodiment, the apparatus 730 may be implemented in a third network node (e.g., a H-PCF, etc.). The receiving unit 731 may be operable to carry out the operation in block 502, and the obtaining unit 732 may be operable to carry out the operation in block 504. Optionally, the receiving unit 731 and/or the obtaining unit 732 may be operable to carry out more or less operations to implement the proposed methods according to the exemplary embodiments of the present disclosure.

In general, the various exemplary embodiments may be implemented in hardware or special purpose chips, circuits, software, logic or any combination thereof. For example, some aspects may be implemented in hardware, while other aspects may be implemented in firmware or software which may be executed by a controller, microprocessor or other computing device, although the disclosure is not limited thereto. While various aspects of the exemplary embodiments of this disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As such, it should be appreciated that at least some aspects of the exemplary embodiments of the disclosure may be practiced in various components such as integrated circuit chips and modules. It should thus be appreciated that the exemplary embodiments of this disclosure may be realized in an apparatus that is embodied as an integrated circuit, where the integrated circuit may comprise circuitry (as well as possibly firmware) for embodying at least one or more of a data processor, a digital signal processor, baseband circuitry and radio frequency circuitry that are configurable so as to operate in accordance with the exemplary embodiments of this disclosure.

It should be appreciated that at least some aspects of the exemplary embodiments of the disclosure may be embodied in computer-executable instructions, such as in one or more program modules, executed by one or more computers or other devices. Generally, program modules include routines, programs, objects, components, data structures, etc. that perform particular tasks or implement particular abstract data types when executed by a processor in a computer or other device. The computer executable instructions may be stored on a computer readable medium such as a hard disk, optical disk, removable storage media, solid state memory, random access memory (RAM), etc. As will be appreciated by one of skill in the art, the function of the program modules may be combined or distributed as desired in various embodiments. In addition, the function may be embodied in whole or partly in firmware or hardware equivalents such as integrated circuits, field programmable gate arrays (FPGA), and the like.

The present disclosure includes any novel feature or combination of features disclosed herein either explicitly or any generalization thereof. Various modifications and adaptations to the foregoing exemplary embodiments of this disclosure may become apparent to those skilled in the relevant arts in view of the foregoing description, when read in conjunction with the accompanying drawings. However, any and all modifications will still fall within the scope of the non-limiting and exemplary embodiments of this disclosure.

1. A method performed by a first network node serving a first network, comprising:
receiving a first message transmitted by a second network node serving a second network, wherein the first message indicates a list of candidate values provided for a quality of service, QoS, attribute of a session by the second network according to an agreement between the first network and the second network; and
obtaining a value for the QoS attribute of the session selected from the list of the candidate values.

2. The method according to claim 1, wherein the QoS attribute of the session is associated with a QoS parameter set, and the list of the candidate values for the QoS attribute corresponds to different configurations of the QoS parameter set.

3. The method according to claim 2, wherein the QoS parameter set includes at least a 5G QoS indicator, 5QI.

4. The method according to claim 1, wherein the QoS attribute of the session is associated with a QoS parameter.

5. The method according to claim 4, wherein the QoS parameter is a 5QI.

6. The method according to claim 4, wherein the first message further indicates a maximum allowed value of one or more other QoS parameters.

7. The method according to claim 1, wherein the first network node is configured to implement a home session management function, H-SMF, and the second network node is configured to implement a visit session management function, V-SMF, wherein the first message is a Nsmf_PDUSession_Create Request or a Nsmf_PDUSession_Update Request.

8. (canceled)

9. The method according to claim 1, wherein the value for the QoS attribute of the session is selected from the list of the candidate values by the first network node based at least in part on subscription data related to the session, the method further comprises:
transmitting a second message towards a third network node which is serving the first network and responsible for QoS authorization for the session, wherein the second message indicates the selected value for the QoS attribute of the session; and
wherein the second message is a Npcf_SMPolicyControl_Create Request or a Npcf_SMPolicyControl_Update Request; or
wherein the value for the QoS attribute of the session is selected from the list of the candidate values by a third network node based at least in part on subscription data related to the session, and wherein the third network node is serving the first network and responsible for QoS authorization for the session; and the method further comprises:
transmitting a third message towards the third network node, wherein the third message indicates the list of the candidate values for the QoS attribute of the session; and
receiving a fourth message transmitted by the third network node, wherein the fourth message indicates the selected value for the QoS attribute of the session; and
wherein the third message is a Npcf_SMPolicyControl_Create Request or a Npcf_SMPolicyControl_Update Request, and wherein the fourth message is a Npcf_SMPolicyControl_Create Response or a Npcf_SMPolicyControl_Update Response.

10-14. (canceled)

15. The method according to claim 10, wherein
the third network node is configured to implement a home policy control function, H-PCF, wherein the subscription data includes a 5QI.

16. (canceled)

17. The method according to claim 1, further comprising:
performing QoS authorization for the session by using the selected value for the QoS attribute of the session.

18-20. (canceled)

21. A method performed by a second network node serving a second network, comprising:
determining a list of candidate values for a quality of service, QoS, attribute of a session, wherein the list of the candidate values is provided by the second network according to an agreement between a first network and the second network; and
transmitting a message towards a first network node serving the first network, wherein the message indicates the list of the candidate values for the QoS attribute of the session.

22. The method according to claim 21, wherein the QoS attribute of the session is associated with a QoS parameter set, and the list of the candidate values for the QoS attribute corresponds to different configurations of the QoS parameter set.

23. The method according to claim 22, wherein the QoS parameter set includes at least a 5G QoS indicator, 5QI.

24. The method according to claim 21, wherein the QoS attribute of the session is associated with a QoS parameter.

25. The method according to claim 24, wherein the QoS parameter is a 5QI.

26. The method according to claim 24, wherein the message further indicates a maximum allowed value of one or more other QoS parameters.

27. The method according to claim 21, wherein the first network node is configured to implement a home session management function, H-SMF, and the second network node is configured to implement a visit session management function, V-SMF, wherein the message is at least one of a Nsmf_PDUSession_Create Request and a Nsmf_PDUSession_Update Request.

28-31. (canceled)

32. A method performed by a third network node serving a first network, comprising:
receiving quality of service, QoS, information transmitted by a first network node serving the first network, wherein the QoS information is related to a list of candidate values provided for a QoS attribute of a session by a second network according to an agreement between the first network and the second network; and
obtaining a value for the QoS attribute of the session selected from the list of the candidate values.

33. The method according to claim 32, wherein the QoS attribute of the session is associated with a QoS parameter set, and the list of the candidate values for the QoS attribute corresponds to different configurations of the QoS parameter set, wherein:
the QoS parameter set includes at least a 5G QoS indicator, 5QI;
the QoS attribute of the session is associated with a QoS parameter; and
the OoS parameter is a 5QI.

34-36. (canceled)

37. The method according to claim 32, wherein the first network node is configured to implement a home session management function, H-SMF, and the third network node is configured to implement a home policy control function, H-PCF, wherein the OS information is included in at least one of a Npcf_SMPolicyControl_Create Request or a Npcf_SMPolicyControl_Update Request.

38-46. (canceled)
